(19) United States
(12) Patent Application Publication
(10) Pub. No.: US 2010/0217867 A1
(43) Pub. Date: Aug. 26, 2010

(54) SYSTEM AND METHOD FOR CREATING AND USING SERVICE DEPENDENCY GRAPHS TO AUTOMATE THE DEVELOPMENT AND DEPLOYMENT OF SERVICE ORIENTED APPLICATIONS

(75) Inventors: Akram Bou-Ghannam, Lake Worth, FL (US); Steven Garfinkle, Cold Spring, NY (US); John Williams Miller, Suwanee, GA (US); Jamshid Abdollahi Vayghan, North Oaks, MN (US)

Correspondence Address: CAHN & SAMUELS, LLP, 1100 17th STREET, NW, SUITE 401, WASHINGTON, DC, 20036, US

(73) Assignee: International Business Machines Corporation, Amonk, NY (US)

(21) Appl. No.: 12/392,328

(22) Filed: Feb. 25, 2009

(51) Int. Cl. G06F 15/16

(52) U.S. Cl. 709/226

(57) ABSTRACT

An embodiment of the invention provides a method for identifying and combining services. More specifically, the method identifies services in a domain and domain concepts within the domain, wherein the domain concepts are input and output of the services. A network of services is created, which includes metadata of the services and relationship data of the services. The relationship data of the services includes relationships of the services to one another and relationships of the services to the domain concepts. A domain ontology is also created, which includes the domain concepts and relationship data of the domain concepts. The relationship data of the domain concepts includes relationships of the domain concepts to one another and relationships of the domain concepts to the services.

### I. FIELD OF THE INVENTION

The present invention is in the field of systems, methods, and computer program products for creating and using service dependency graphs to automate the development and deployment of service oriented applications.

### II. BACKGROUND OF THE INVENTION

The increasing adoption of service oriented architectures is accelerating the development, deployment, and usage of service oriented business applications. Enterprises are creating and maintaining environments for hosting different types of services including those that are bound and discovered over the Internet (e.g., web services), and those that are discovered and bound inside a Java Virtual Machine (JVM), e.g., Open Services Gateway Initiative (OSGI) services.

A JVM is a set of computer software programs and data structures which use a virtual machine model for the execution of other computer programs and scripts. The model used by a JVM accepts a form of computer intermediate language commonly referred to as Java bytecode. This language conceptually represents the instruction set of a stack-oriented, capability architecture.

### III. SUMMARY OF THE INVENTION

An embodiment of the invention provides a method for identifying and combining services. More specifically, the method identifies services in a domain by querying registries for services provided over the Internet and/or services inside of a Java virtual machine. The services inside of the Java virtual machine include services deployed in an OSGI platform. Domain concepts are identified within the domain, wherein the domain concepts are input and output of the services. A network of services is created, which includes metadata of the services and relationship data of the services. The relationship data of the services includes relationships of the services to one another and relationships of the services to the domain concepts. A domain ontology is also created, which includes the domain concepts and relationship data of the domain concepts. The relationship data of the domain concepts includes relationships of the domain concepts to one another and relationships of the domain concepts to the services.

The method receives a request from a user for a service that satisfies constraints based on the domain concepts. At least two services within the network are selected that satisfy the constraints to create selected services, wherein the services are selected based on the relationship data of the domain concepts in the domain ontology. In one embodiment, the constraints can only be satisfied by two or more of the services. In at least one embodiment, a first service and at least one second service are selected from the network. An output of the first service is obtained; and, all or part of the output is input into the second service. Moreover, an output of at least one third service is obtained; and, all or part of that output is input into the first service. In an alternative embodiment, the output of the first service is transformed to create a transformed domain concept; and, the transformed domain concept is input into the second service. The selected services are combined to create a combined service; and, the user is notified of the combined service.

A system according to an embodiment of the invention includes a domain having domain concepts, wherein the domain concepts are input into services and output from the services. A network of services is provided, wherein the network includes metadata of the services and relationship data of the services. The relationship data includes relationships of the services to one another and relationships of the services to the domain concepts. A domain ontology is also provided having the domain concepts and relationship data of the domain concepts. The relationship data includes relationships of the domain concepts to one another and relationships of the domain concepts to the services.

The system further includes a user interface for receiving a request from a user for a service that satisfies constraints based on the domain concepts. A processor combines at least two services within the network that satisfy the constraints. In one embodiment, the constraints can only be satisfied by two or more of the services. The processor combines the services based on the relationship data of the domain concepts in the domain ontology. In at least one embodiment, the services include a first service and at least one second service from the network. The first service includes an output, wherein all or a part of the output is input into the second service. Moreover, at least one third service from the network has an output that is input into the first service. In an alternative embodiment, the system has a second processor for transforming the output of the first service into a transformed domain concept, wherein the transformed domain concept is input into the second service.

### IV. BRIEF DESCRIPTION OF THE DRAWINGS

The present invention is described with reference to the accompanying drawings. In the drawings, like reference numbers indicate identical or functionally similar elements.

FIG. 1 is a schematic diagram illustrating a system for creating and using service dependency graphs to automate the development and deployment of service oriented applications according to an embodiment of the invention;

FIG. 2 is a schematic diagram illustrating a service for returning a base product price according to an embodiment of the invention;

FIG. 3 is a schematic diagram illustrating a service for returning a discounted price according to an embodiment of the invention;

FIG. 4 is a schematic diagram illustrating a combination of the services illustrated in FIGS. 2 and 3;

FIG. 5 is a schematic diagram illustrating a combination of services according to an embodiment of the invention;

FIG. 6 is a schematic diagram illustrating a service for returning a recycle fee according to an embodiment of the invention;

FIG. 7 is a schematic diagram illustrating a model for an order according to an embodiment of the invention;

FIG. 8 is a schematic diagram illustrating a combination of services according to an embodiment of the invention;

FIG. 9 is a flow diagram illustrating a method for identifying and combining services according to an embodiment of the invention;

FIG. 10 is a schematic diagram illustrating services and domain concepts according to an embodiment of the invention;

FIG. 11 is a schematic diagram illustrating a system according to an embodiment of the invention;

FIG. 12 illustrates a computer program product according to an embodiment of the invention; and

FIG. 13 is a diagram for a system and method for deployment.

### V. DETAILED DESCRIPTION OF THE DRAWINGS

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

With the proliferation of services, and with the rapid introduction of new services, an embodiment of the invention provides tools and methods to discover and combine services to maximize the benefits of the vast collection of services that are increasingly made available. Thus, users are given tools and methods that allow them to easily and dynamically (at run-time) discover new services, and to combine the outputs of existing services to achieve their requirements. These tools can greatly reduce the cost of developing service oriented business applications because they help maximize reuse through the implementation of flexible and dynamically configurable systems.

When planning, architecting, and designing an information technology (IT) solution to meet certain requirements, an IT architect is provided with all available services in the environment (the enterprise), and how these services relate to each other and to the domain ontology. An ontology describes the logical structure of a domain, its concepts and the relations between them. Moreover, ontology refers to computer-based resources that represent agreed domain semantics. An ontology consists of relatively generic knowledge that can be reused by different kinds of applications or tasks.

An embodiment of the invention discovers services to create and maintain an explicit Service Dependency Network (also referred to herein as “SDN” or the “network”). The SDN is used not only to provide the architect or solution designer with a relational view of all of the services in the environment, but in addition, the SDN is used by the system (also referred to herein as the “tool”) of an embodiment of the invention to dynamically combine services to satisfy the requirements (requests and constraints) of the user. The specific result a user may desire often could not be provided by a single service. However, the desired result could be arrived at by a combination of services, each providing a piece of the puzzle. A tool is provided that allows a user (human or machine) to easily create a situational application that satisfies his/her requirements. This tool allows the user to specify his/her request via a high-level constraint (rule). The elements (parameters or variables) of the user's (or client) constraint are concepts included in a domain ontology. Based on the user's constraint, the tool is then able to create and deploy a new service that satisfies the user's constraint. The new service is typically a combination (choreograph) of existing services discovered via the SDN created by the tool.

At least one embodiment of the invention provides systems and methods to automate the development and deployment of service-oriented applications by creating and using a service dependency model. The system discovers all types of services deployed in the enterprise, which includes but not limited to: services that are bound and discovered over the Internet (web services) and services that are bound and discovered inside a JVM, e.g., services deployed in the OSGI platform.

The SDN and model are created, which include service metadata and the relationship to the domain ontology. The system accepts requests from users which include constraints on the ontological concepts in the domain, and a request to find a service or create a new service to satisfy the constraints. The SDN and domain ontology are used to fulfill the user's request.

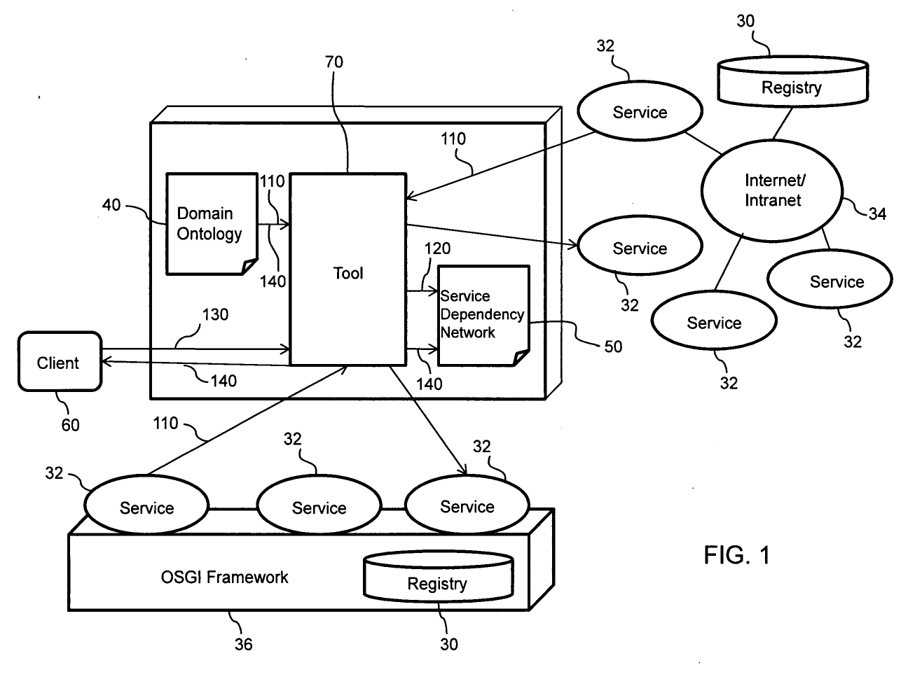

FIG. 1 illustrates a system and method according to an embodiment of the invention. The discovery steps are performed where various registries 30 (e.g., registries provided over the Internet/Intranet 34 and registries deployed in an OSGI platform 36) are queried to discover available services 32 (110). Given the available services 32 and a domain ontology 40, an SDN 50 is created (120). The SDN 50 relates the services 32 to each other and to the concepts in the domain ontology 40. In at least one embodiment, the SDN model is represented in resource definition framework (RDF, a standard for describing resources) or any similar representation that allows the representation and addition of metadata to the SDN 50. The SDN 50 presents an informative view to the user/client 60 that shows how all available services 32 are related, and how they relate to the domain concepts. The user 60 uses the SDN view to specify ontological constraints (130), and the tool 70 uses the SDN 50 to determine how to satisfy the user's constraints (140). The tool 70 is also able to deploy new services 32 that satisfy and implement the constraints of the user 60.

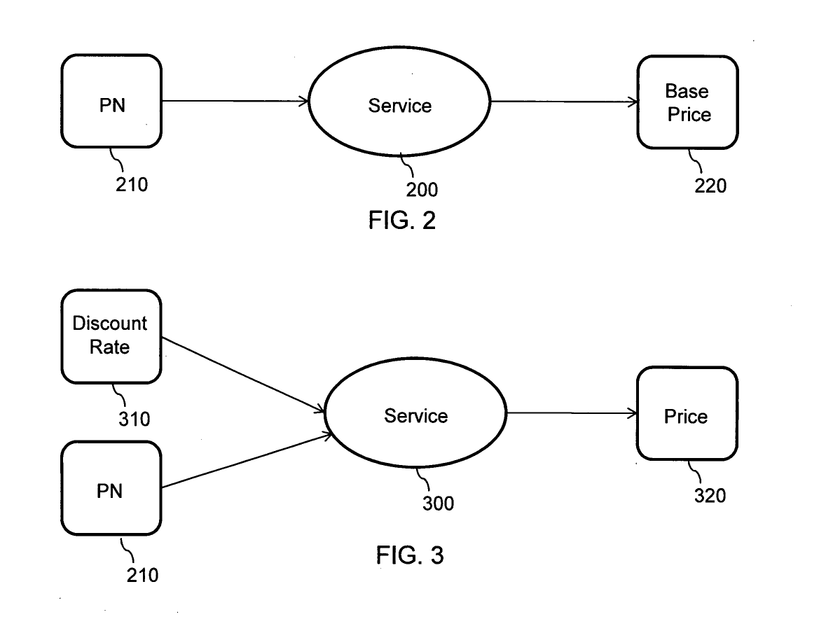

FIG. 2 illustrates an example of a service 200 according to at least one embodiment of the invention. The price of a product sold by enterprise E is provided by the service 200 that can return the base product price 220 given the product part number 220. The base price 220 and part number 220 are domain concepts represented in the domain ontology.

The actual price 320 a customer pays for a certain product depends on the type of discount rate 310 the customer has as established in the contract maintained between the customer and the enterprise. So, a service 300 is created to calculate the actual price 320 based on the discount rate 310 and part number 220 as illustrated in FIG. 3.

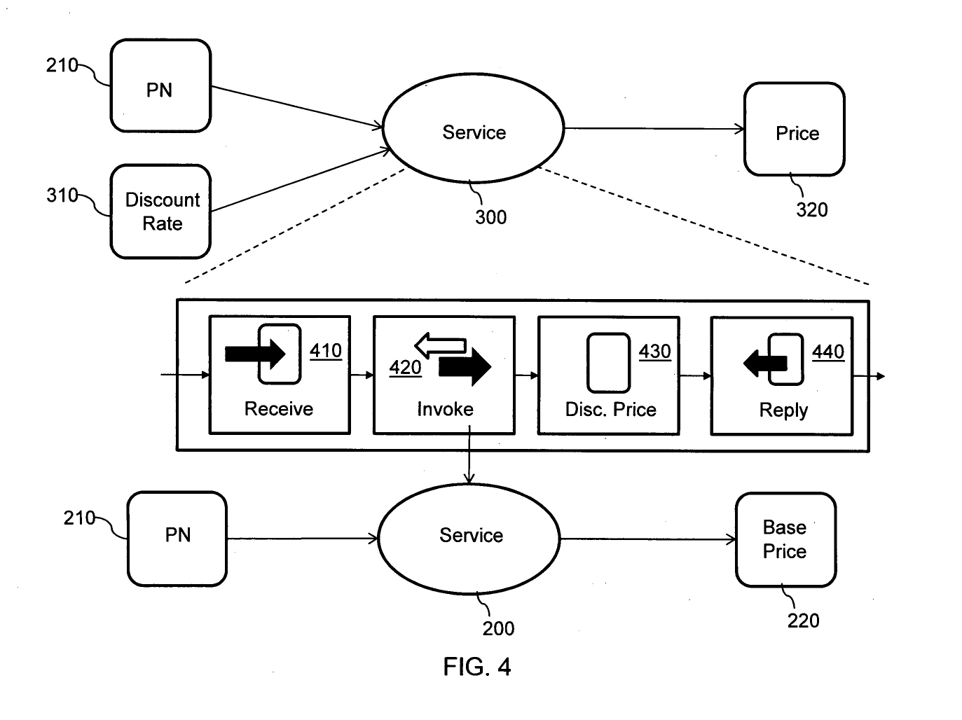

As illustrated in FIG. 4, the service 300 uses the service 200 to provide its output. For example, the service 300 is used by business processes and applications in the enterprise, like an application that calculates the total price of an order. A service takes in an order object and returns the same order but with the total order price filled in. The receive 410, invoke 420, discounted price 430, and reply 440 commands are standard commands in Business Process Execution Language (BPEL). FIG. 4 depicts a BPEL flow or script; and, the commands 410-440 are the individual commands or activities within the flow graph.

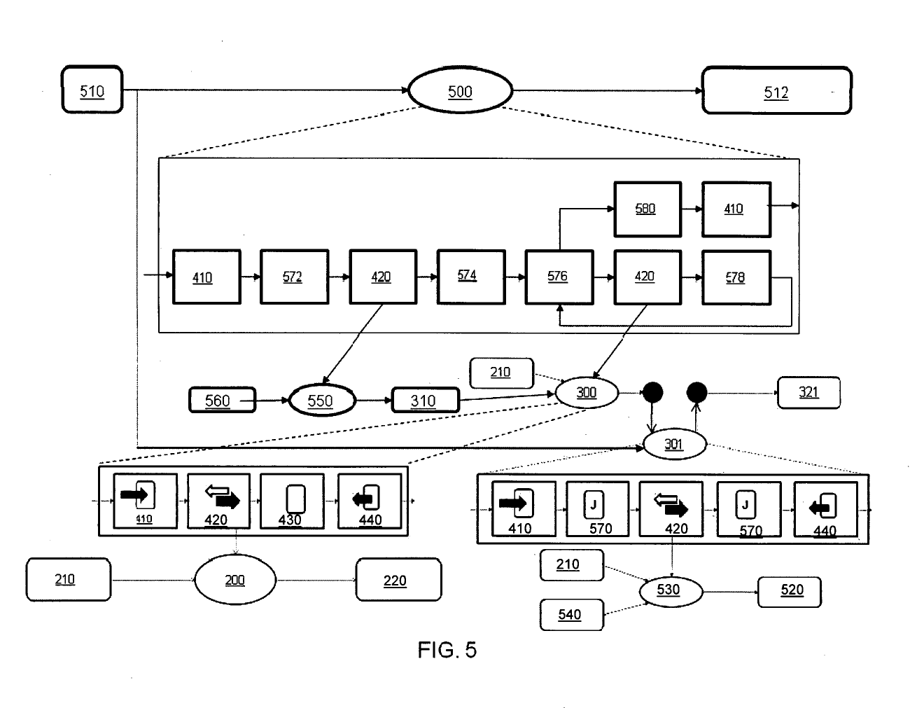

FIG. 5 illustrates an exemplary process flow implemented by the service and how it uses other services including 300. FIG. 5 illustrates a typical example of the landscape of services available and used in an enterprise. More specifically, the system of an embodiment herein creates a new service by combining existing services (200, 300, etc). A service 301 is added whereby the old output of the service 300 (i.e., price 320) is now input into the service 301, which delivers the actual (new) price 321 output. Also, input to the service 301 is Order 510. The order 510 is also an input to a new service 500, which outputs an order total price 512. The script shown below the service 301 is actually the script implemented inside the service 301. The service 301 generates the new price 321, which is adjusted by the value of the recycle fee 520. In other words the new price 321=the old price 320+the recycle fee 520, which is the same constraint the user has requested.

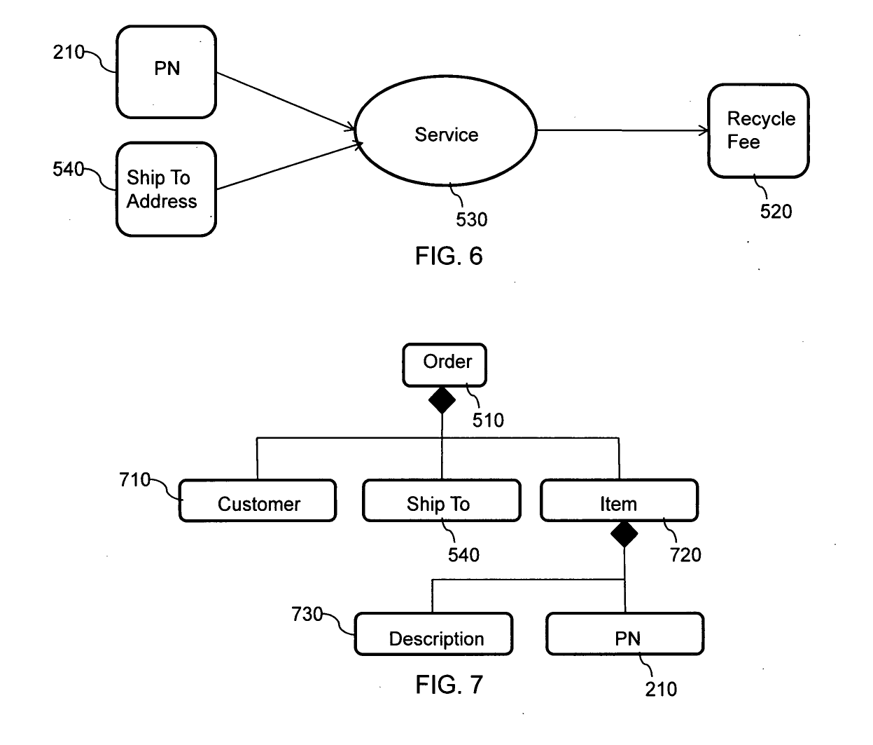

As certain states and countries began enforcing regulations to charge recycling fees on computer products (e.g., screens, monitors, and other computer components), the prices of certain products have to be increased by the amount of the recycle fee paid on that product for the state or country it was sold in. For example, as illustrated in FIGS. 5 and 6, a group in enterprise E creates and publishes a new service 530 that can provide the product recycle fee 520, given the product part number 220 and the geography (location where the product is sold) represented by the ship-to address 540.

The business process and business applications modify the services and replace it with the new service 500 that calculates the new product price 321 (base product price 320 plus the product recycle fee 520). The development of the service 500 and the replacement of the previous service with the new service 500 (by every client application that uses the service 500) is a costly and time consuming process. These development tasks are completed automatically by the system and methods herein for identifying and combining services. Therefore, the development costs are avoided or reduced.

Using the systems provided herein, a client can view the SDN created, and is able to select the product price domain concept, right click on it, and then declaratively specify a constraint (rule). For example, the user can specify the constraint: Price=Price+Recycle Fee. Using the tool, the user can additionally specify that he wants to create and deploy a service to satisfy the above constraint. The tool examines the specified constraint (Price=Price+Recycle Fee), and using the SDN created and maintained by the tool, the tool determines the Price and Recycle Fee for each of the concepts. Thus, the tool avoids or reduces the costs of developing or purchasing a new service.

For example, in regards to price, the service 300 provides the product price 320 if the product part number 220 and the discount rate 310 are available. A service 550 can provide the discount rate 310 given a customer ID 560. In at least one example, checking the SDN, no service is found that provides the customer ID 560, so the tool checks the ontological representation of the SDN (i.e., the domain ontology). FIG. 5 includes BPEL flows, which include the receive 410, invoke 420, discounted price 430, and reply 440 commands. The BPEL flows also include Java snippet 570, get customer ID 572, prepare PM 574, white 576, p=p+Price 578, and order total 580 commands.

As illustrated in FIG. 7, the tool determines that order 510 contains (includes) the customer ID 560 domain concept. Further, no service can produce the product part number PN 220, so the service checks the ontological representation of the SDN. The tool determines that order 510 contains (includes) the PN 220 domain concept.

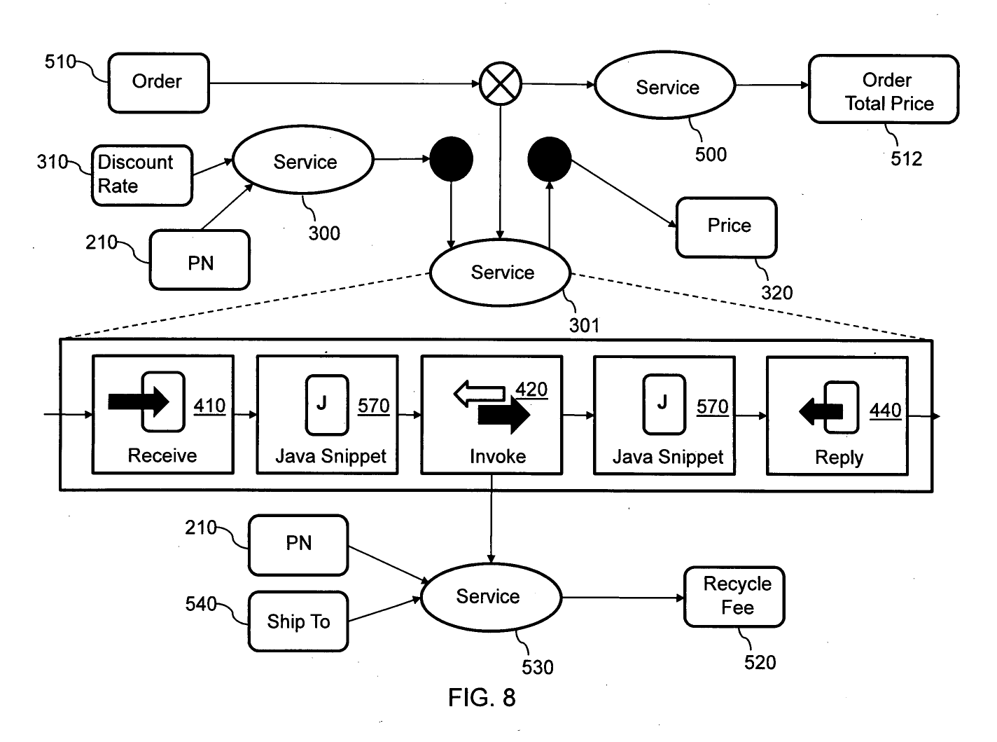

In the same example, the service 530 provides the product recycle fee 520 given the part number 220. The tool uses the domain ontology as represented in FIG. 7 as a simplified model for an order ontological concept to identify the source for customer ID 710 and part number 220. The domain ontology also includes item 720 and description 730. Since the service 300 produces the price 320 domain concept, and since the user constraint specifies that the price needs to be updated with the recycle fee 520, the tool inserts a script (process flow) at the output of the service 300 that is implemented by the service S3.1. As illustrated in FIG. 8, this script invokes the service 530 to get the recycle fee 520 value, and provides the system 530 with the product part number 220 and the ship-to address 540 input concepts that are extracted from the order object. The script then adds the price to the recycle fee 520 and returns the price 320 concept similar to what 300 would have returned.

The original service is now replaced with the new service 500. The inputs and outputs of the service 500 are the same as those of the previous service. The only change is the addition of a process flow at the output of the service 300 that implements the new user constraint. The tool generated the SDN, related the SDN to the domain ontology, and used the SDN to satisfy the new user requirement (constraint).

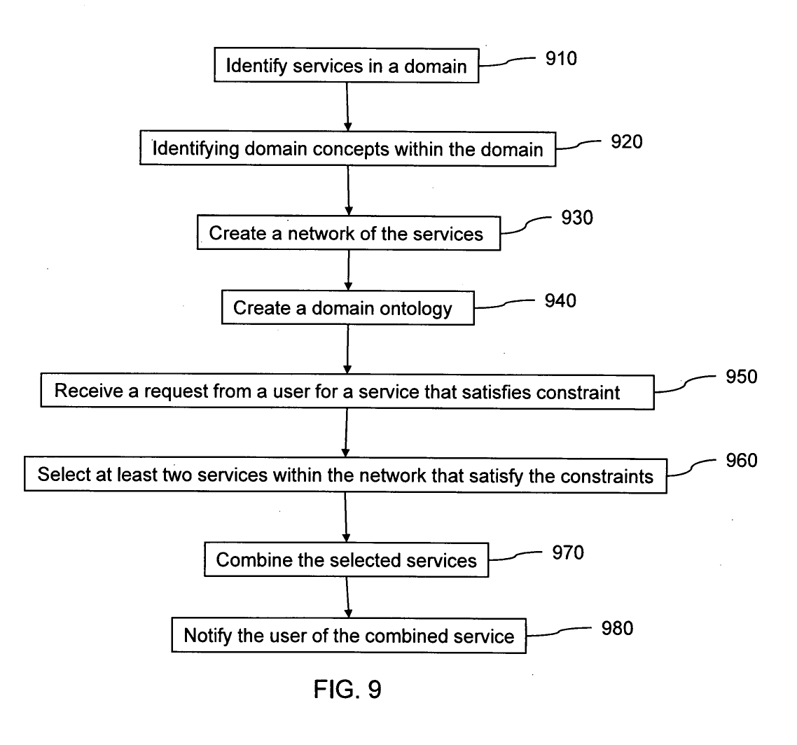

FIG. 9 is a flow diagram illustrating a method for identifying and combining services according to an embodiment of the invention. More specifically, the method identifies services in a domain (910) by querying registries for services provided over the Internet and/or services inside of a Java virtual machine. The services inside of the Java virtual machine include services deployed in an OSGI platform. Domain concepts are identified within the domain (920), wherein the domain concepts are input and output of the services. For example, as illustrated in FIG. 3, the domain concepts discount rate 310 and part number 220 are input into the service 300; the domain concept price 320 is output from the service 300.

A network of services (also referred to herein as the “Service Dependency Network” or “SDN”) is created, which includes metadata of the services and relationship data of the services (930). The relationship data of the services includes relationships of the services to one another and relationships of the services to the domain concepts. As described above, services are discovered to create and maintain an explicit SDN. The SDN provides the architect or solution designer with a relational view of all of the services in the environment.

A domain ontology is also created, which includes the domain concepts and relationship data of the domain concepts (940). The relationship data of the domain concepts includes relationships of the domain concepts to one another and relationships of the domain concepts to the services. An ontology describes the logical structure of a domain, its concepts and the relations between them. Moreover, ontology refers to computer-based resources that represent agreed domain semantics. An ontology consists of relatively generic knowledge that can be reused by different kinds of applications or tasks.

The method receives a request from a user for a service that satisfies constraints based on the domain concepts (950). At least two services within the network are selected that satisfy the constraints to create selected services (960), wherein the services are selected based on the relationship data of the domain concepts in the domain ontology. In one embodiment, the constraints can only be satisfied by two or more of the services. A tool is provided that allows a user (human or machine) to easily create a situational application that satisfies his/her requirements. This tool allows the user to specify his/her request via a high-level constraint (rule). The elements (parameters or variables) of the user's (or client) constraint are concepts included in the domain ontology. Based on the user's constraint, the tool is then able to create and deploy a new service that satisfies the user's constraint.

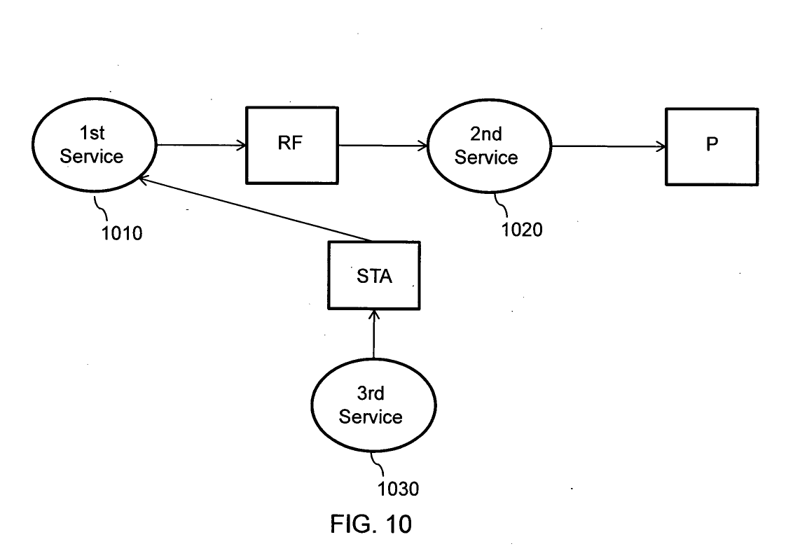

In at least one embodiment of the invention, a first service and at least one additional service (also referred to herein as the “second service”) are selected from the network. An output of the first service is obtained; and, at least a portion of the output is input into the additional service. For example, as illustrated in FIG. 10, an output (Recycle Fee 520) is output from a first service 1010 and input into a second service 1020. Using the output from the first service 1010, the second service 1020 outputs the Price 320. Additionally, an output of at least one sub-service from the network (also referred to herein as the “third service”) is obtained; and, all or part of that output is input into the first service. In FIG. 10, in order to obtain the output from the first service 1010, a third service 1030 is utilized. Specifically, a ship-to address (STA) is output from the third service 1030 and input into the first service 1010. In an alternative embodiment, the output of the first service is transformed to create a transformed domain concept; and, the transformed domain concept is input into the additional service. For example, in FIG. 2, the base price 220 output from the service 200 can be transformed from dollar units to euro units.

The selected services are combined to create a combined service (970); and, the user is notified of the combined service (980). The SDN is used by the system to dynamically combine services to satisfy the requirements (requests and constraints) of the user. The specific result a user may desire often could not be provided by a single service. However, the desired result could be arrived at by a combination of services, each providing a piece of the puzzle.

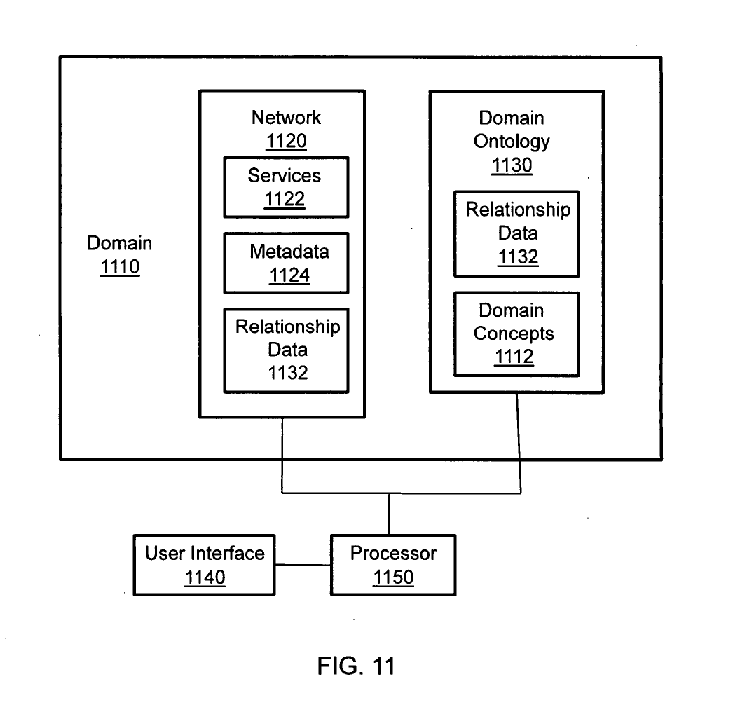

FIG. 11 is a schematic diagram illustrating a system according to an embodiment of the invention. More specifically, the system includes a domain 1110 having domain concepts 1112, wherein the domain concepts 1112 are input into services 1122 and output from the services 1122. For example, in FIG. 3, discount rate 310 and part number 220 are input into the service 300; and, price 320 is output from the service 300.

A network of services 1120 is provided, wherein the network includes metadata 1124 of the services 1122 and relationship data 1126 of the services 1122. The relationship data 1126 includes relationships of the services 1122 to one another and relationships of the services 1122 to the domain concepts 1112. As described above, services are discovered to create and maintain an explicit SDN. The SDN provides the architect or solution designer with a relational view of all of the services in the environment.

A domain ontology 1130 is also provided having the domain concepts 1112 and relationship data 1132 of the domain concepts 1112. The relationship data 1132 includes relationships of the domain concepts 1112 to one another and relationships of the domain concepts 1112 to the services 1122. An ontology describes the logical structure of a domain, its concepts and the relations between them. Moreover, ontology refers to computer-based resources that represent agreed domain semantics. An ontology consists of relatively generic knowledge that can be reused by different kinds of applications or tasks.

The system further includes a user interface 1140 for receiving a request from a user for a service that satisfies constraints based on the domain concepts 1112. A processor 1150 combines at least two services 1122 within the network 1122 that satisfy the constraints. In one embodiment, the constraints can only be satisfied by two or more of the services 1122. A tool is provided that allows a user (human or machine) to easily create a situational application that satisfies his/her requirements. This tool allows the user to specify his/her request via a high-level constraint (rule). The elements (parameters or variables) of the user's (or client) constraint are concepts included in the domain ontology. Based on the user's constraint, the tool is then able to create and deploy a new service that satisfies the user's constraint.

The processor 1150 combines the services 1122 based on the relationship data 1132 of the domain concepts 1112 in the domain ontology 1130. The SDN is used by the system to dynamically combine services to satisfy the requirements (requests and constraints) of the user. The specific result a user may desire often could not be provided by a single service. However, the desired result could be arrived at by a combination of services, each providing a piece of the puzzle.

In at least one embodiment, the services 1122 include a first service and at least one additional service (also referred to herein as the “second service”) from the network. The first service includes an output, wherein at least a portion of the output is input into the additional service. Moreover, at least one sub-service (also referred to herein as the “third service”) from the network has an output that is input into the first service. In an alternative embodiment, the system has a second processor for transforming the output of the first service into a transformed domain concept, wherein the transformed domain concept is input into the additional service.

At least one embodiment of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, at least one embodiment of the invention can take the form of a computer program product accessible from a computer-usable or computer-readable medium providing program code for use by or in connection with a computer or any instruction execution system. For the purposes of this description, a computer-usable or computer readable medium can be any apparatus that can e, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

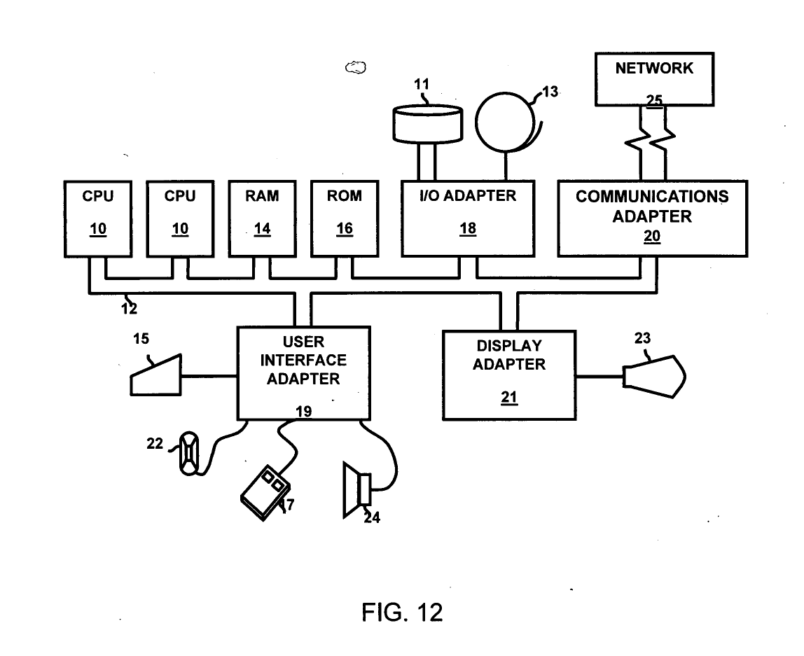

A representative hardware environment for practicing at least one embodiment of the invention is depicted in FIG. 12. This schematic drawing illustrates a hardware configuration of an information handling/computer system in accordance with at least one embodiment of the invention. The system includes at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

While it is understood that process software may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a director on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

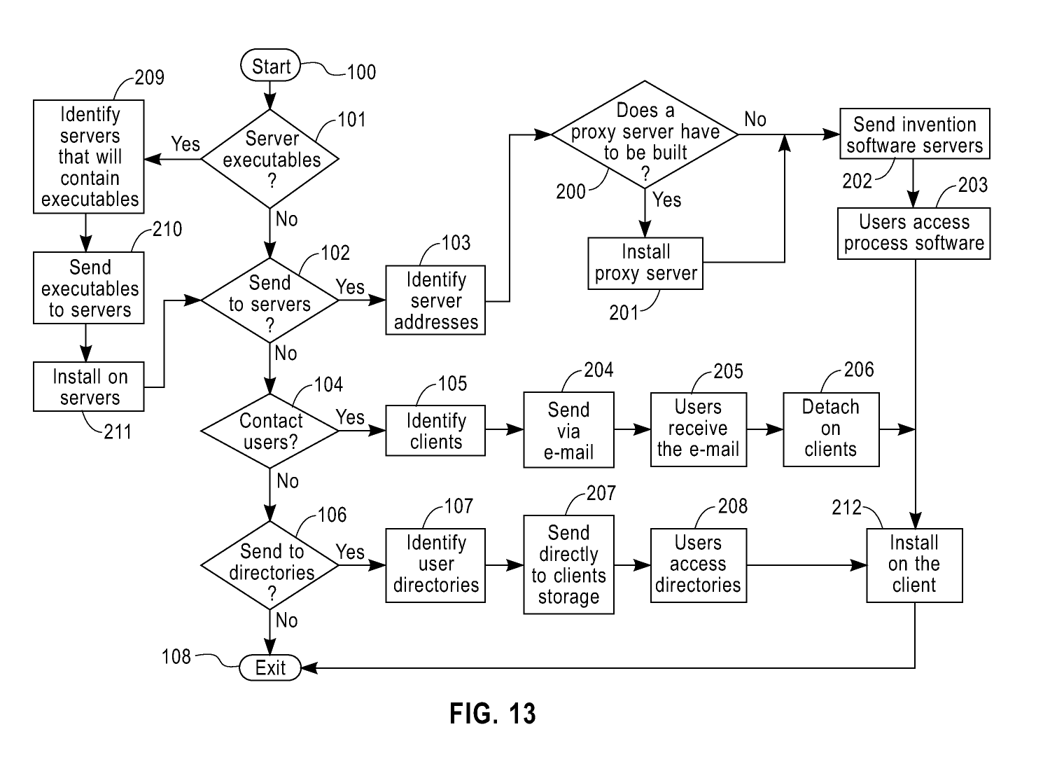

FIG. 13 is a diagram for a system and method of deployment. Step 100 begins the deployment of the process software. The first thing is to determine if there are any programs that will reside on a server or servers when the process software is executed 101. If this is the case then the servers that will contain the executables are identified 209. The process software for the server or servers is transferred directly to the servers' storage via FTP or some other protocol or by copying though the use of a shared file system 210. The process software is then installed on the servers 211.

Next, a determination is made on whether the process software is be deployed by having users access the process software on a server or servers 102. If the users are to access the process software on servers then the server addresses that will store the process software are identified 103.

A determination is made if a proxy server is to be built 200 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 201. The process software is sent to the servers either via a protocol such as FTP or it is copied directly from the source files to the server files via file sharing 202. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 203. Another embodiment is to have the servers automatically copy the process software to each client and then run the installation program for the process software at each client computer. The user executes the program that installs the process software on his client computer 212 then exits the process 108.

In step 104 a determination is made whether the process software is to be deployed by sending the process software to users via e-mail. The set of users where the process software will be deployed are identified together with the addresses of the user client computers 105. The process software is sent via e-mail to each of the users' client computers. The users then receive the e-mail 205 and then detach the process software from the e-mail to a directory on their client computers 206. The user executes the program that installs the process software on his client computer 212 then exits the process 108.

Lastly a determination is made on whether to the process software will be sent directly to user directories on their client computers 106. If so, the user directories are identified 107. The process software is transferred directly to the user's client computer directory 207. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 208. The user executes the program that installs the process software on his client computer 212 then exits the process 108.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method, including:
identifying services in a domain;
identifying domain concepts within said domain, wherein said domain concepts are input and output of said services;
creating a network of said services including metadata of said services and relationship data of said services, said relationship data of said services including relationships of said services to one another and relationships of said services to said domain concepts;
creating a domain ontology including said domain concepts and relationship data of said domain concepts, said relationship data of said domain concepts including relationships of said domain concepts to one another and relationships of said domain concepts to said services;
receiving a request from a user for a service that satisfies constraints based on said domain concepts;
selecting at least two services within said network that satisfy said constraints to create selected services;
combining said selected services to create a combined service; and
notifying said user of said combined service.

2. The method according to claim 1, wherein said selecting of said services is based on said relationship data of said domain concepts in said domain ontology.

3. The method according to claim 1, wherein said selecting of said services includes selecting a first service and at least one additional service from said network, and wherein said combining of said selected services includes:
obtaining an output of said first service; and
inputting at least a portion of said output into said additional service.

4. The method according to claim 3, wherein said obtaining of said output of said first service includes:
obtaining an output of at least one third service from said network; and
inputting at least a portion of said output of said third service into said first service.

5. The method according to claim 1, wherein said selecting of said services includes selecting a first service and at least one additional service from said network, and wherein said combining of said selected services includes:
transforming an output of said first service to create a transformed domain concept; and
inputting said transformed domain concept into said additional service.

6. The method according to claim 1, wherein said constraints can only be satisfied by two or more of said services.

7. The method according to claim 1, wherein said identifying of said services includes querying registries for services provided at least one of over the Internet and services inside of a Java virtual machine.

8. The method according to claim 7, wherein said services inside of said Java virtual machine includes services deployed in an open services gateway initiative (OSGI) platform.

9. A method, including:
identifying services in a domain;
identifying domain concepts within said domain, wherein said domain concepts are input and output of said services;
creating a network of said services including metadata of said services and relationship data of said services, said relationship data of said services including relationships of said services to one another and relationships of said services to said domain concepts;
creating a domain ontology including said domain concepts and relationship data of said domain concepts, said relationship data of said domain concepts including relationships of said domain concepts to one another and relationships of said domain concepts to said services, wherein said domain ontology includes a logical structure of a domain, domain concepts, and relationships between said domain concepts;
receiving a request from a user for a service that satisfies constraints based on said domain concepts;
selecting at least two services within said network that satisfy said constraints to create selected services, wherein said selecting of said services is based on said relationship data of said domain concepts in said domain ontology;
combining said selected services to create a combined service; and
notifying said user of said combined service.

10. The method according to claim 9, wherein said selecting of said services includes selecting a first service and at least one additional service from said network, and wherein said combining of said selected services includes:
obtaining an output of at least one sub-service from said network;
inputting at least a portion of said output of said sub-service into said first service;
obtaining an output of said first service; and
inputting at least a portion of said output into said additional service.

11. The method according to claim 9, wherein said selecting of said services includes selecting a first service and at least one additional service from said network, and wherein said combining of said selected services includes:
transforming an output of said first service to create a transformed domain concept; and
inputting said transformed domain concept into said additional service.

12. A system, including:
a domain including domain concepts, wherein said domain concepts are input into services and output from said services;
a network of said services, said network including metadata of said services and relationship data of said services, said relationship data of said services including relationships of said services to one another and relationships of said services to said domain concepts;
a domain ontology including said domain concepts and relationship data of said domain concepts, said relationship data of said domain concepts including relationships of said domain concepts to one another and relationships of said domain concepts to said services;
a user interface for receiving a request from a user for a service that satisfies constraints based on said domain concepts; and
a processor for combining at least two services within said network that satisfy said constraints.

13. The system according to claim 12, wherein said processor combines said services based on said relationship data of said domain concepts in said domain ontology.

14. The system according to claim 12, wherein said at least two services includes a first service and at least one additional service from said network, wherein said first service includes an output, and wherein at least a portion of said output is input into said additional service.

15. The system according to claim 14, further including at least one sub-service from said network, wherein at least a portion of an output of said sub-service is input into said first service.

16. The system according to claim 12, wherein said at least two services includes a first service and at least one additional service from said network, wherein said first service includes an output, wherein said system further includes a second processor for transforming said output into a transformed domain concept, and wherein said transformed domain concept is input into said additional service.

17. The system according to claim 12, wherein said constraints can only be satisfied by two or more of said services.

18. A program storage device readable by machine, tangibly embodying a program of instructions executable by the machine to perform a method including:
identifying services in a domain;
identifying domain concepts within said domain, wherein said domain concepts are input and output of said services;
creating a network of said services including metadata of said services and relationship data of said services, said relationship data of said services including relationships of said services to one another and relationships of said services to said domain concepts;
creating a domain ontology including said domain concepts and relationship data of said domain concepts, said relationship data of said domain concepts including relationships of said domain concepts to one another and relationships of said domain concepts to said services;
receiving a request from a user for a service that satisfies constraints based on said domain concepts;
selecting at least two services within said network that satisfy said constraints to create selected services;
combining said selected services to create a combined service; and
notifying said user of said combined service.

19. The program storage device according to claim 18, wherein said selecting of said services is based on said relationship data of said domain concepts in said domain ontology.

20. The program storage device according to claim 18, wherein said selecting of said services includes selecting a first service and at least one additional service from said network, and wherein said combining of said selected services includes:
obtaining an output of said first service; and
inputting at least a portion of said output into said additional service.

21. The program storage device according to claim 20, wherein said obtaining of said output of said first service includes:
obtaining an output of at least one third service from said network; and
inputting at least a portion of said output of said third service into said first service.

22. The program storage device according to claim 18, wherein said selecting of said services includes selecting a first service and at least one additional service from said network, and wherein said combining of said selected services includes:
transforming an output of said first service to create a transformed domain concept; and
inputting said transformed domain concept into said additional service.

23. The program storage device according to claim 18, wherein said constraints can only be satisfied by two or more of said services.

24. The program storage device according to claim 18, wherein said identifying of said services includes querying registries for services provided at least one of over the Internet and services inside of a Java virtual machine.

25. The program storage device according to claim 24, wherein said services inside of said Java virtual machine includes services deployed in an open services gateway initiative (OSGI) platform.
